(19) United States
(12) Patent Application Publication
(10) Pub. No.: US 2016/0196403 A1
(43) Pub. Date: Jul. 7, 2016

(54) METHOD AND ARRANGEMENT FOR FINDING A SECOND OPINION FOR DISEASE USING MODERN DATABASE, SEARCH AND MATCHING TECHNOLOGY INTEGRATED WITH A SOCIAL MEDIA

(71) Applicant: YOUR.MD AS, Oslo (NO)

(72) Inventor: Harald JELLUM, Oslo (NO)

(73) Assignee: YOUR.MD AS, Oslo (NO)

(21) Appl. No.: 14/912,026

(22) PCT Filed: Aug. 8, 2014
(86) PCT No.: PCT/NO2014/050142

§ 371 Date: Feb. 12, 2016

(30) Foreign Application Priority Data
Aug. 12, 2013 (NO) 20131099

(51) Int. Cl. G06F 19/00

(52) U.S. Cl. CPC G06F 19/3425; G06F 19/3418; G06F 19/3443

(57) ABSTRACT

Techniques for finding a second opinion for a disease using modern database, search and matching technology integrated with a social media making it possible for patients, relatives, family, friends, doctors, nurses, holistic and alternative medicine professionals or other professionals in the health profession to find a second opinion for the disease. The solution is global and may be made available for all patients, professionals in the health profession, family, friends, and others with the same disease or other relatives.

### CROSS REFERENCE TO RELATED APPLICATIONS

This application is a U.S. National Stage patent application of PCT/NO2014/050142, filed on Aug. 8, 2014, which claims priority to Norwegian Patent Application No. 20131099, filed on Aug. 12, 2013, each one of which is hereby incorporated by reference in entirety.

### FIELD OF THE INVENTION

The invention relates to a new way for patients, relatives, family, friends, doctors, nurses, holistic and alternative medicine professionals or other professional in the health profession to find a second opinion for a disease.

### BACKGROUND OF THE INVENTION

Background art relates to:

Electronic Patient Records (EPR): These are solutions where a patient's medical record is stored electronically and where different doctors and systems can read this such that one does not have to bring the physical records between different treatment locations. Lately there have been several initiatives and are often local and limited by laws and regulations. The invention is not related to this topic, but may be integrated with such systems to provide the doctors with guidance on alternative treatments.

“Yellow Pages” for doctors: There are currently several directory services to find doctors, These often contain essentially only the name and address of the doctor. These are very often local. Examples are zocdoc.com and Doctor Ute respectively in the UK and U.S. These lack essentially all the information from the various sources that are integrated into the invention. These also lack the possibility that is available in social media to connect to a group with others who have similar disease. A search for a doctor in these portals relies on the doctors having added just the keyword specified in the search. Often this is very limited compared to what the doctors actually offer in regards of treatments.

Network for doctors: In recent years it own network of doctors has appeared. This is equivalent to “LinkedIn for doctors.” Examples are www.doximity.com. This is not in the same area as the invention, but synergies might appear if the invention is able to index these networks and making content available as part of the invention to find doctors with expertise in the disease in question.

Information Databases: There are information databases for diseases, drugs, equipment etc. These databases are often relatively static. They often lack the automatic update on everything happening in the world of innovations in the health industry. They also lack automatic notification to those interested in the latest development around a disease. Examples of this can be www.patient.co.uk in England which is designed for English residents. Another barrier is often the language. These information Databases are typically made in a language that you must master in order to utilize the services of the portal. They also lack the dimension of social medias where it is possible to chat/conversation with others who having the same disease.

Search engines: Many find information about diseases using search engines like Google, Bing, Yahoo and others. The challenge with these is that it generates too much “noise”, and a lot of time is often spent to find good, relevant articles. These are also typical keyword-based which requires that exact keywords are used. Missing one of the keywords, or using one keyword too much, can have serious consequences for result.

Medical sensors/“trackers”: These are devices in which the patient carries on the body to measure activity, pressure, temperature etc. The doctor can then read/download the result to analyze the patient's condition. These devices exist as separate instruments and also as separate applications that you can download to your smartphone. Examples are www.ginger.io. This is not part of the present invention, but may eventually help to provide data to the present invention which can find the second opinion based on other devices showing similar patterns.

Online doctors/forum: These are typical websites where you ask an online doctor for advice. These types of services are often performed in an open to public web service, and hence all other users can see the FAQ. There are many local players in this area. Examples are www.doctoronline.no, www.netdoctor.co.uk.

### SUMMARY OF THE INVENTION

Based on what is currently available in various technologies, the present invention comprises a new way to find a second opinion. None of the above described solutions provides a solution where web information is collected from all hospitals, private clinics, holistic and alternative treatments, and connecting databases, all world news in health both from newspapers, magazines, journals and social networking sites—a total of more than 3 million sources. This is put this together using advanced search technology along with social network where each disease automatically is arranged in a unique group with others having the same disease. The groups will also comprise smart data such as recent news and research, success stories and best practices. All these elements are combined to give a user the best advice related to getting a second opinion.

The invention make use of selected health relevant sources, which is optimized for diseases and provide the utility for content search using mathematical descriptive models of diseases that makes the search less dependent on the use of correct keywords.

The Online doctors/forum may provide part of the contents of the present invention when it comes to the task of being able to generate advises on second opinion. Online doctors may be selectable as cooperating channels and partners.

The reasons for getting a second opinion may be to get more opinions on the treatment. Some doctors tend to more conservative medicine whilst others are more open to modern development in medicine. A second opinion may reveal a different more positive way of treatment. A second opinion is also contributing to the quality assurance of the selection of diagnose and treatment. No doctors know everything and no one makes 100% correct decisions all the time. The market of the invention is global, available for basically all people with access to the internet via a PC, cell phone or a tablet, or other devices connected to the network. The invention can also be used as an aid for professional practitioners in the health profession. The invention may be made available to users through a web-portal on the Internet.

The method and arrangement is provided through a continuous reading of web information from all hospitals, private clinics, alternative treatments and databases, online medical experts, input from social groups for each disease, all world news related to health from all newspapers, magazines, journals and social web-sites, a total of over 3 million sources. Further it combines this together with the use of advanced search technology with social network where each disease automatically is allocated its own group together with others with the same disease. The groups will also contain smart data such as recent news and research, success stories and best practices. All these elements is put together to give the best possible advice in related to the task of getting a second opinion.

When the word disease is used in this document, it should be understood that this shall comprise but not be limited to the meaning: illness, sickness, disease, malady, ailment, disorder, complaint, or affection.

The claimed invention is defined by the accompanying independent claim and further embodiments by the dependent claims.

### BRIEF DESCRIPTION OF THE DRAWINGS

The description of the invention is accompanied by the figures of which:

FIG. 1 is a block diagram overview of the system.

FIG. 2 is flow chart of the system.

### DETAILED DESCRIPTION OF THE INVENTION

The invention make use of databases, and advanced search and matching technology integrated into social media platforms.

The invention provides a new, more efficient and safer way to find a second opinion. This may lead to a more appropriate treatment and increased life quality for many people. Currently around 200 000 deaths each year in USA alone is caused by improper treatments. 50% of all people with a disease in the U.S. never gets the opportunity of a second opinion. 30% of those who receive a second opinion were given a different treatment. Within breast cancer treatment, more than 50% gets a different and more positive treatment after having received a second opinion.

Based on the above, there is a need for a more efficient way of finding a second opinion. It is especially important in cases where life and death and major economic consequences are in play. The above-mentioned problems and shortcomings related to prior art are addressed by the invention described herein.

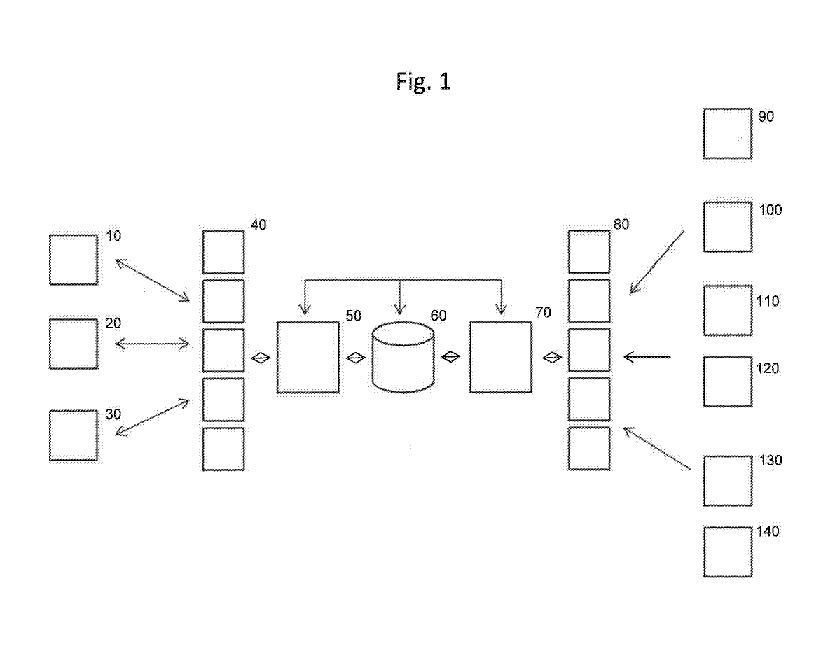

The invention provides a new and novel way to find a second opinion. The invention is based on the use of databases, advanced search and matching technology combined with social media. As described in FIG. 1 the invention comprises a large server farm consisting of servers hosting Crawlers (80), Search & Matching (70), Database (60), Social Media (50), and Web servers (40). These servers are operated by an ASP provider offering a service where the number of servers is automatically scalable according to the load of the system (e.g.: Cloud Computing). The purpose of Crawlers (80) is initially read all information sources (90, 100, 110, 120, 130, 140) and to store these in the database (60). Then the Crawlers (80) continuously will read all information sources (90, 100, 110, 120, 130, 140) and look for changes and updates. These are then stored in the database (60).

The information sources consist of Websites (90) of public hospitals, private clinics and holistic and alternative treatments, crawled similarly as from a standard search engine, with a major difference in that the present invention comprises the Search and Matching (70) that will make a filtering of the web content and remove as much as possible of the noise like advertisements from other domains. The content is categorized by a structure such as menu structures of Web pages and then store it in the database (60). Information and facts about diseases, treatments, drugs and the like is collected from medical databases, private and public records (100). Some of the registers will be public, while others can be private where access may be necessary to be purchased. There can be multiple registries within the information source (100).

Online medical experts (110) may be physicians affiliated directly or through cooperative partners. These will assist users with second opinion in real-time online through the social media channel of present the invention. Consumers (120) can be patients, professionals in the health profession, family, friends, others with the same disease and that provides experiences and advice of a disease, It may for example comprise a user who have experienced recovery by a certain treatment and that this story is shared in the social media (50) of the present invention. News (130) comprises a news stream continuously updated with news from newspapers, magazines, radio, TV, organizations, municipalities, agencies, political parties or the like. This service is provided by 3rd party providers available in the market (e.g., MoreOver, Retriever, Cyberwather or others). The Search and Matching (70) will filter out all the news related to diseases and store these news in the database (60) together with associated disease. As with the news (60), news feed will be received from/provided by Forum, Blogs, Social Networks (140) provided by 3rd party sources. The users (10, 20, 30) of the present invention will access the invention via an internet portal which is made available through web servers (40). When the database (60) has received all information from the information sources (90, 100, 110, 130, 140) except for patients, professionals in health profession, family, friends, others with the same disease (120) that will be added once the invention is applied, all users (10, 20, 30) will be able to find help getting a second opinion from day one. A user may reach and participate in groups that are of interest. Here the user will automatically meet others with the same interest and automatically get advice on second opinion and be able to follow latest development and other users success stories. One of the unique characteristics of the present invention is that all the information from all the sources of information (90, 100, 110, 120, 130, 140) is a unique collection of global data which combined provides the user the best possible way to get a Second Opinion which may be of great importance for the life quality of the user.

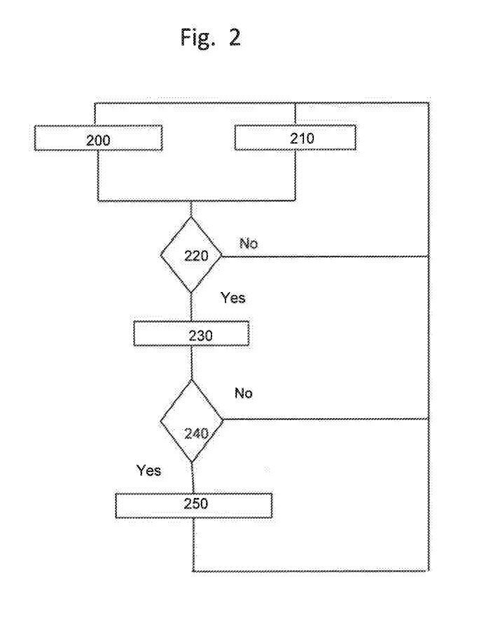

A flowchart of the system of the present Invention is described in FIG. 2. All sources of information, all users and all social media (200) are read (210). If there is no new (220) information then continue to read all information sources and users (200,210). If there are new (220) information available, test whether the change leads to a new match for any of the user (230). If it leads to a new match (240) then update the database and the socially media with the new connections/links so that these are updated and available for the users (250). Continue to read/monitor all information sources and all users and social media (200,210).

The present invention also comprises a number of other properties that handles the possibility to find diseases based on symptoms. A user may enter all his/hers symptoms and the system will automatically suggest possible diseases that match the symptoms. Users (10, 20, 30) may get notifications automatically comprising for example new treatments, and new success stories.

Users (10, 20, 30) can filter information such as treatment sites/facilities, filtering may be based on closeness to a facility, amount of publicity, evaluation scores given by other patients, whether they are public, private or holistic and alternative.

The information is categorized so that it is easy to navigate to find wanted information. The searches and matches will be stored and categorized.

The groups created by Social Media (50) provide in an intelligent manner monitoring of any information related to diseases in the groups and provide the user with for example news related to the diseases, success stories, drugs, specialist doctors, and erroneous treatments.

Other key features is the ability each user (10, 20, 30) have to create a volunteer profile about themselves where they can upload experiences, images, medications, treatments, experiences and advices.

1. Method and arrangement for finding a second opinion related to a disease using modern Database, Search & Matching technology integrated with Social Media making it possible for patients, relatives, family, friends, doctors, nurses, holistic and alternative medicine or other professionals in the health profession to find a second opinion related to a disease, comprising:
a) combining databases, advanced search and matching technology combined with social media;
b) a search engine continuously reading Websites of public hospitals, private clinics and holistic and alternative treatments, medical databases, private and public records, on-line medical experts, News, Forums, Blogs, social networks, and feedback from users;
c) categorizing the information provided in a) and b) and stored the information in a database;
d) providing the information to a social network;
e) providing the information through a web portal to patients, relatives, family, friends or other relatives, professional practitioners such as doctors, nurses, researchers, therapists, or others associated with health and medicine;
f) continuous searching and matching of any changes in the social network and updating the database, facilitating the user's ability to find a second opinion;
g) finding one or more of a second opinion, others who can provide a second opinion, treatment facilities with expertise, success stories, best practices, or news updates concerning treatments.

2. Method and arrangement according to claim 1, the search and matching providing users with the ability to search for all diseases comprising data from all sources of information, and sorting and categorizing matches according to the symptoms, severity, duration of treatment, location, location on the body, contagion, risk, cost, or other parameter typical for the diseases.

3. Method and arrangement according to claim 1, the search and matching providing users with the ability to define the search using entire sentences, other diseases, news, documents or other description of the type of disease being searched.

4. Method and arrangement according to claim 1, Social media providing users with the ability to join and create groups with others having the same disease.

5. Method and arrangement according to claim 1, Social media providing users with the ability to send messages, chat, create public forum, share documents in the group(s) of which they are participating.

6. Method and arrangement according to claim 1, the search and matching, database and social media providing users with the ability to receive automatic update notifications concerning diseases.

7. Method and arrangement according to claim 1, the database providing users with the ability to upload text, audio and video of himself/herself to a profile that is made visible to other users.

8. Method and arrangement according to claim 1, the database and search & matching providing users with the ability to describe the symptoms and based on the description of the symptoms provide a list of possible diseases.

9. Method and arrangement according to claim 1, the database and search and matching providing users with the ability to upload questions, pictures and descriptions and providing the ability for other users to answer and upload their answers to the questions.

10. Method and arrangement according to claim 1, the database and search and matching providing users with the ability to communicate with the online experts.

11. Method and arrangement according to claim 1, the database and Social media providing users with the ability to share their profiles with other external social networks.

12. Method and arrangement according to claim 1, the database providing users with the ability to see statistics on who, when and what others have viewed on your profile.

13. Method and arrangement according to claim 1, the database providing users with the ability to display banner ads through the web portal or externally through 3rd party providers comprising network to various media channels.

14. Method and arrangement according to claim 1, the database and search & Matching providing users information with the ability to automatically be optimized for Web search engines on the web comprising all content from all data sources.

15. Method and arrangement according to claim 1, the database and search & Matching providing users with the ability to see success stories of the various diseases.
